(19) United States
(12) Patent Application Publication
(10) Pub. No.: US 2024/0067160 A1
(43) Pub. Date: Feb. 29, 2024

(54) REDUNDANT LOW VOLTAGE BATTERY CHARGING CONTROL SYSTEM FOR A VEHICLE

(71) Applicant: FCA US LLC, Auburn Hills, MI (US)

(72) Inventors: Rudolf Kharpuri, Auburn Hills, MI (US); Zhentao Xie, Auburn Hills, MI (US); Richard Roy, Rochester Hills, MI (US)

(21) Appl. No.: 17/900,108

(22) Filed: Aug. 31, 2022

(51) Int. Cl. B60W 20/50; B60L 3/00; H02J 7/00; H02J 9/06

(52) U.S. Cl. CPC B60W 20/50; B60L 3/003; B60L 3/0046; H02J 7/0047; H02J 9/061; B60K 6/28; B60W 2510/244

(57) ABSTRACT

A hybrid vehicle having an engine, a high voltage battery, a low voltage battery and at least one charge enabling component and system for operating the same includes enabling charging of the low voltage battery from a high voltage battery through a DC-DC converter, charging the low voltage battery with the high voltage battery and the at least one charge enabling component comprising at least the DC-DC converter and detecting a fault in the at least one charge enabling component. Based on the fault, the system performs enabling charging of the low voltage battery from a starter generator based on the fault and disabling charging of the low voltage battery from the high voltage battery using the DC-DC converter.

### TECHNICAL FIELD

The present disclosure relates generally to a low voltage battery charging system, and more specifically, to a system and method for charging a low voltage battery, such as a 12-volt battery, in a vehicle system that has a high voltage system.

### BACKGROUND

The statements in this section merely provide background information related to the present disclosure and does not constitute prior art.

Many hybrid electric vehicles include a high voltage system, such as a 48-volt system and a low voltage system such as a 12-volt system. Many components within the vehicle operate using a 12-volt system. However, to operate the electric motors of the vehicle, a higher voltage may be used. The 12-volt battery may be referred to as a low voltage battery and the 48-volt battery, a high voltage battery or a traction battery.

The vehicle needs to maintain the charging of both the high voltage battery and the low voltage battery. The high voltage battery may be charged by plugging into an external charger or the operation of the vehicle including regeneration and the like. The high voltage battery may be used to charge the low voltage battery through a DC-DC. When the state of charge of the high voltage battery is above a predetermined threshold, the 12 voltage battery charges using a DC-DC converter. When the high voltage battery state of charge is below a threshold state of charge, a DC-DC converter and alternator combination are used to charge the 12-volt battery. A controller adjusts the motor torque for an optimal power split. When the torque demand of the electric machine falls below a threshold, which indicates a loss in the inverter, the controller charges the low-voltage battery by using only the alternator. In a hybrid vehicle, various components are used for charging the 12-volt battery. The components may be referred to as charge enabling components.

### SUMMARY

The present disclosure engages a backup charging supply when a state of charge of the traction battery is low, the DC-DC converter fails, the traction battery fails, the communication bus fails, the contactor is welded, the transmission fails, the inverter fails and the electric machine fails.

In one aspect of the disclosure, a method of operating a hybrid vehicle having an engine, a high voltage battery, a low voltage battery and at least one charge enabling component includes enabling charging of the low voltage battery from a high voltage battery through a DC-DC converter, charging the low voltage battery with the high voltage battery and at least one charge enabling component comprising at least the DC-DC converter and detecting a fault in the at least one charge enabling component. Based on the fault, the system performs enabling charging of the low voltage battery from a starter generator based on the fault and disabling charging of the low voltage battery from the high voltage battery using the DC-DC converter.

In another aspect of the disclosure, a hybrid vehicle includes an engine, a high voltage battery, a low voltage battery and at least one charge enabling components comprising at least a DC-DC converter and a supervisory controller programmed to enable charging of the low voltage battery from a high voltage battery through the DC-DC converter. The supervisory controller is programmed to determine a fault in the at least one charge enabling component. The supervisory controller is programmed to, based on the fault, enable charging of the low voltage battery from a starter generator based on the fault and disable charging of the low voltage battery from the high voltage battery using the DC-DC converter.

In a further aspect of the disclosure, A method of operating a hybrid vehicle having a high voltage battery, a low voltage battery and at least one charge enabling component comprising enabling charging of the low voltage battery from a high voltage battery through a DC-DC converter, charging the low voltage battery with the high voltage battery and at least one charge enabling component comprising at least the DC-DC converter, detecting a limp home mode being entered and based on the limp home mode being entered, enabling charging of the low voltage battery from a starter generator and disabling charging of the low voltage battery from the high voltage battery using the DC-DC converter.

Further areas of applicability of the teachings of the present disclosure will become apparent from the detailed description, claims and the drawings provided hereinafter, wherein like reference numerals refer to like features throughout the several views of the drawings.

### DRAWINGS

The drawings described herein are for illustration purposes only and are not intended to limit the scope of the present disclosure in any way.

FIG. 1 is a block diagrammatic view of a hybrid electric vehicle and the components for controlling and charging a low voltage battery therein.

FIG. 2 is a flowchart of a method for controlling the charging of the low voltage battery of the system of FIG. 1.

### DETAILED DESCRIPTION

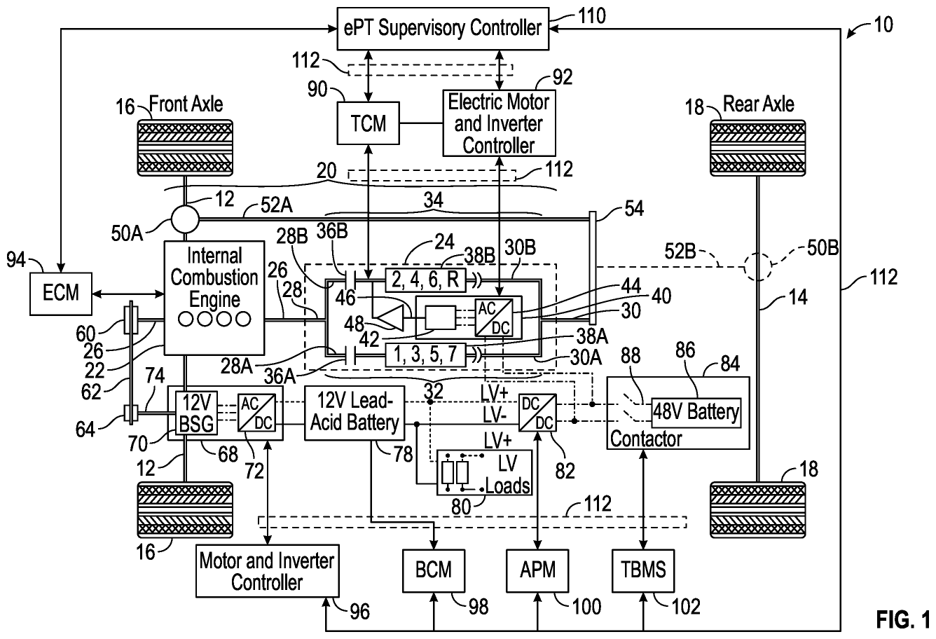

Referring now to FIG. 1, a vehicle 10 is illustrated having a front axle 12 and a rear axle 14. The front axle has front wheels 16 that are rotated by the front axle 12. The rear axle 14 has rear wheels 18 coupled thereto. The front axle 12 is a driven axle that is driven by the powertrain 20. The powertrain 20 has an internal combustion engine 22 and, in this example, a hybrid dual clutch transmission or simply transmission 24. The internal combustion engine 22 has a crankshaft 26 that is coupled to an input shaft 28 of the transmission 24. In this example, the input shaft is selectively coupled to an output shaft 30 of the transmission 24. In this example, the transmission 24 has a first sub-transmission 32 and a second sub-transmission 34. The input shaft 28 to the transmission 24 is divided into a first sub-transmission input shaft 28A associated with the first sub-transmission 32 and a second sub-transmission input shaft 28B. The first sub-transmission 32 has a first output shaft 30A and the second sub-transmission 34 has an output shaft 30B that together are coupled to the output shaft 30 of the transmission 24. A clutch 36A selectively couples the sub-transmission input shaft 28A to the sub-transmission output shaft 30A. A clutch 36B selectively couples the sub-transmission input shaft 28B to the sub-transmission output shaft 30B.

A gear set 38A couples the sub-transmission input shaft 28A to the sub-transmission output shaft 30A. In this example, the gear set 38A controls various gears as one, three, five and seven. A gear set 38B couples the sub-transmission input shaft 28B to the output shaft 30B. In this example, gear set 38B provides gear two, gear four, gear six and reverse. Depending upon the gear needed, the clutches 36A and 36B are controlled to engage and disengage the sub-transmission input shafts 28A, 28B and the sub-transmission output shafts 30A, 30B.

The transmission 24 has an electric drive unit 40 associated therewith. In this example, the electric drive unit is disposed within the transmission 24. The electric drive unit 40 has an electric motor 42 and an inverter 44. The electric motor 42 has a motor shaft 46 that is coupled to a coupler 48 that is coupled to the sub-transmission output shaft 30B, in this example.

The motor 42 also operates as a generator such as during regenerative braking to provide power to charge the high voltage battery 86 through the inverter 44. The motor 42 is used for various functions including propelling the vehicle electrically without the engine 22, assisting the engine 22 and providing a boost to the propulsion power, starting the engine or charging a high voltage battery as described further below.

The inverter 44 converts DC electric power to AC electric power to drive the electric motor 42. A differential 50A having an input shaft 52A is coupled to the front axle 12. The input shaft 52A of the differential 50A is coupled to the output shaft 30 of the transmission 24 by a coupler 54. Rotational motion by the output shaft 30 is ultimately provided to the input shaft 52 of the differential 50A to drive the front axle 12, in this example. The system is easily adapted to provide a rear differential 50B having an input shaft 52B coupled to the coupler 54. The crankshaft 26 of the engine 22 is coupled to a pulley 60 that has a belt 62 that is operatively coupled to a pulley 64. When the crankshaft 26 rotates, the pulley 60 rotates causing the belt 62 to move and then pulley to move as well. An electric unit 68 includes a belt-driven starter generator 70 (BSG) that is electrically coupled to an inverter 72. Although the term belt-driven is used, a chain or direct gear coupling may be used. The BSG 70 has a shaft 74 coupled to the pulley 64. The BSG 70 acts as a starter motor to start the engine 22. The BSG 70 also acts as a generator to charge a low voltage battery 78. The BSG 70 uses the DC voltage from the low voltage battery 78 to rotate the pulley 64 to start the internal combustion engine 22.

The low voltage battery 78 is ultimately coupled to a plurality of low voltage loads 80. The low voltage loads include but are not limited to the BSG 70, various microcontrollers used to control the operation of various functions in the vehicle, radiator fans, power steering and other vehicle systems. Ultimately, the loads 80 will deplete the low voltage battery 78 so a source of charging for the low voltage battery is provided. The low voltage battery 78 in this example is a 12-volt battery.

The low voltage battery is in electrical communication with a DC-DC converter 82. The DC-DC converter 82 is electrically coupled to a high voltage electrical unit 84 that includes a high voltage battery 86 and a contactor 88. The high voltage battery 86, in this example, is a 48-volt battery. The contactor 88 is a switch that electrically couples the high voltage battery 86 to other components of the vehicle including the DC-DC converter 82 and the inverter 44 disposed within the transmission 24. The high voltage battery 86 is used to charge the low voltage battery 78 through the DC-DC converter 82. The high voltage battery 86 powers the motor 42 through the inverter 44. The motor 42 also operates as a generator such as during regenerative braking to provide power to charge the high voltage battery 86 through the inverter 44.

Various control modules are used to control the logic for operating the various components of the vehicle. In this example, a transmission control module 90 controls the clutches 36A, 36B and a synchronizer to synchronize the shifting of the gear sets 38A, 38B. The transmission control module 90 ultimately allows torque to be transmitted to the wheels 16 through the front axle 12 by way of power from the engine 22 or the high voltage battery through the contactor 88. The transmission control module 90 also enables the charging of the high voltage battery 86 by connecting the engine 22 to the motor 42 or by connecting the motor 42 to the wheels 16 during deceleration to provide regenerative braking. The transmission control module 90 generates a signal corresponding to the failure of the transmission.

An electric motor and inverter controller 92 is illustrated coupled to the electric drive unit 40. The electric motor and inverter controller 92 control the operation of the motor 42 and the inverter 44. The functions of the electric motor and inverter controller 92, in this example, are set forth as a separate module. In other examples, the electric motor and inverter controller 92 have functions incorporated into the transmission control module 90.

An engine control module 94 controls the operation of the engine 22 to allow the engine to provide power to propel the vehicle 10 as well as supporting the operation of the BSG 70 and the alternator function associated therewith. The associator function of the BSG is an alternator to charge the low voltage battery 78. The BSG 70 may also support the charging of the high voltage battery 86 through the DC-DC converter 82. Ultimately, the engine control module 94 controls the spark and fuel inputs and the timing thereof to provide output power to the crankshaft 26.

An electric motor and inverter controller 96 controls the inputs and outputs to the electrical unit 68 and ultimately to the BSG 70 and the inverter 72. The electric motor and inverter controller 96 generates a low voltage inverter failure signal corresponding to the failure of the inverter 72.

A body control module 98 is coupled to the low voltage battery 78. The body control module 98 generates signals such as a state of charge signal corresponding to the state of charge of the low voltage battery 78, a voltage signal corresponding to the voltage of the low voltage battery 78, a current signal corresponding to the current flowing within the low voltage battery 78 and a temperature signal corresponding to the temperature of the low voltage battery 78.

An ignition signal is communicated from the body control module 98 in response to an ignition switch or another type of enabling device and is communicated to the supervisory controller 110 to determine whether the vehicle is in an on-state or an off-state.

An auxiliary power module 100 (APM) is coupled to the DC-DC converter 82. The auxiliary power module 100 generates a failure signal corresponding to the failure of the DC-DC converter 82. The electric motor and inverter controller 92 generates a signal corresponding to the failure of the inverter 44.

A traction battery management system 102 is coupled to the high voltage electrical unit 84. The traction battery management system 102 generates signal corresponding to the operation of the contactor. For example, the traction battery management system 102 knows whether the contactor has been requested to be opened. The traction battery management system 102 also generates a signal corresponding to when the contactor has been welded. The contactor being welded corresponds to the contacts begin stuck in a closed position. The traction battery management system 102 may also generate signals corresponding to the function of the battery 86 including but not limited to a state of charge signal corresponding to the state of charge of the high voltage battery, a voltage signal corresponding to the voltage of the high voltage battery 86, a current signal corresponding to the current of the high voltage battery 86 and a temperature signal corresponding to the temperature of the high voltage battery 86.

An electric power train (ePT) supervisory controller or supervisory controller 110 is used to control and monitor various signals that are generated by the various modules 90-102. A communication bus 112 is generally shown as communicating the signals to and from the various modules including the supervisory controller 110. The supervisory controller 110 determines a loss of communication to the various modules 90-102. That is, the supervisory controller 110 may monitor for loss of communication with the DC-DC converter 82 through the auxiliary power module 100. The supervisory controller 110 also determines a loss of communication with the BSG 70 through signals or lack of signals from the motor and inverter controller 96. The supervisory controller also determines a lack of communication with the high voltage battery 86 through the traction battery management system 102. The traction battery management system 102 also provides the status signals for the contactor to the supervisory controller. A contactor welded signal and a contactor requested to be open signal is communicated from the traction battery management system to the supervisory controller 110. A transmission failure signal is communicated from the transmission control module 90 the supervisory controller 110. A DC-DC converter failure signal is communicated from the auxiliary power module 100 to the supervisory controller 110. A 48-volt motor inverter fault signal is communicated from the electric motor and inverter controller 92 to the supervisory controller 110.

The supervisory controller 110 also generates a DC-DC converter enable signal and a DC-DC converter disable signal. Likewise, a BSG enable signal and BSG disable signal may also be generated by the supervisory controller and communicated to the BSG 70 to ultimately control the operation of the battery starter generator.

The supervisory controller 110 monitors the system's behavior to determine whether there are various subsystems faults or malfunctions that may limit the safe operation of the vehicle. The vehicle may operate in a “limp home” mode so that the vehicle may continue to operate various functions to allow the vehicle to be moved to a desired location to remedy the faults and provide service thereto. The limp home mode is the operation of the vehicle in the presence of a fault or malfunction to provide a system output that is limited for safe operation of the vehicle.

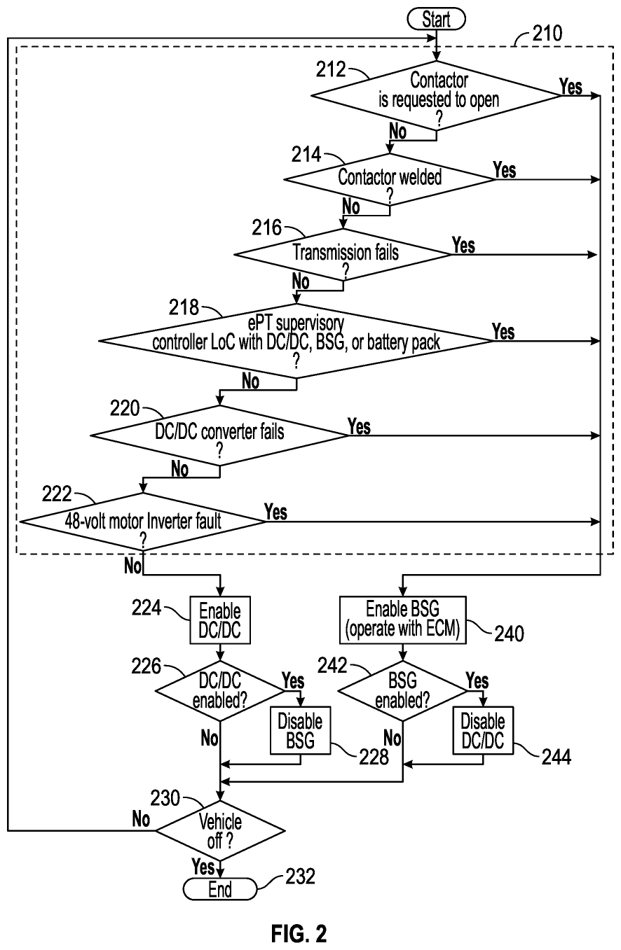

Referring now to FIG. 2, a flowchart of a method for operating the vehicle is set forth. The supervisory controller 110 is a microprocessor-based system programmed to control and monitor various functions of the vehicle. A limp home mode 210 may be determined by the supervisory controller 110. The limp home mode, in this example, determines the operation of various systems, or subsystems, as provided herein. As will be described below, the determination of a limp home mode in step 210 determines whether to enable the BSG 70 to enable the charging of the low voltage battery as described in more detail below. The determination of limp home mode may be performed in steps 212-222. Any one or more of the conditions set forth below causes the vehicle to enter the limp home mode. However, an ultimate determination of limp home mode is not required. Steps 212-222 are illustrated in a particular order; however, the order may be changed in other examples without varying the scope of the disclosure.

In step 212, the contactor is requested to open. Various components may request the contactor to be opened based on sensed conditions such as but not limited to thermal issues, bad communication and bad sensors such as the current sensor. When the contactor is not requested to be open, step 214 determines the contactor is welded. Steps 212 and 214 ultimately receive signals from the traction battery management system 102.

When the contactor is not welded in step 214, step 216 determines whether the transmission has failed through a signal from the transmission control module 90. When the transmission has not failed, step 218 determines whether a loss of communication has been determined at the supervisory controller 110. Ultimately, the loss of communication with the DC-DC converter 82, the BSG 70 and the battery pack 86 may all be determined. When no loss of communication is determined in step 218, step 220 determines whether the DC-DC converter fails through a DC-DC converter failure signal from the auxiliary power module 100.

When the DC-DC converter 82 has not failed in step 220, step 222 determines whether the inverter 44 has failed. When no inverter fault is determined in step 222, step 224 is performed. Step 224 enables the DC-DC converter 82 to charge the low voltage battery 78 from the high voltage battery 86 by an enable signal generated by the supervisory controller 110. The enable signal is communicated to the DC-DC converter 82 through the auxiliary power module 100. In step 226, when the DC-DC converter is enabled, the charging of the low voltage battery 78 through the BSG 70 is disabled in step 228. When the DC-DC converter is not enabled in step 226 and after step 228, step 230 determines whether the vehicle is off. If the vehicle is off, the system ends in step 232. If the vehicle is not off (the vehicle is on), the system repeats at step 210.

Referring back to steps 212-222, when the contactor is requested to open in step 212 the contactor is welded, in step 214, the transmission has failed in step 216, a loss of communication is determined with the DC-DC converter, the BSG or the battery pack in step 218, the DC-DC converter has failed in step 220 or the high voltage motor inverter 44 has a fault, the vehicle is in a limp home mode and step 240 is performed. In step 240, the supervisory controller 110 generates an enable BSG signal that enables the charging of the battery 78 with the BSG 70. The enable signal is communicated from the supervisory controller 110 to the BSG 70. The action of the supervisory controller 110 is coordinated with other modules, in this case, the engine control module 94. When the BSG has been enabled to charge the low voltage battery 78 in step 242, step 244 disables the DC-DC converter 82 from charging the 48-volt battery. That is, the supervisory controller 110 generates a disable signal that is communicated to the auxiliary power module 100 to disable the DC-DC converter 82 from charging the low voltage battery 78.

When the BSG in step 242 is not enabled and after step 244, steps 230, 230 and/or step 210 or step 212 is performed.

As described above, certain vehicle functions or subsystem functions are used to enable or disable the charging of the low voltage battery 78 from various system. Ultimately, when there is no limp home mode enabled, the DC-DC converter allows the high voltage battery 86 to charge the low voltage battery 78. When the limp home mode is enabled by a detection of fault or various conditions provided in steps 212-222, the BSG 70 is used to charge the low voltage battery 78.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method of operating a hybrid vehicle having an engine, a high voltage battery, a low voltage battery and at least one charge enabling component comprising:
enabling charging of the low voltage battery from a high voltage battery through a DC-DC converter;
charging the low voltage battery with the high voltage battery and the at least one charge enabling component comprising at least the DC-DC converter;
detecting a fault in the at least one charge enabling component; and
based on the fault,
enabling charging of the low voltage battery from a starter generator based on the fault; and
disabling charging of the low voltage battery from the high voltage battery using the DC-DC converter.

2. The method of claim 1 wherein enabling charging of the low voltage battery from a starter generator is performed before disabling charging of the low voltage battery from the high voltage battery using the DC-DC converter.

3. The method of claim 1 further comprising when no fault is detected and after enabling, disabling the starter generator from charging the low voltage battery and enabling charging of the low voltage battery through the DC-DC converter.

4. The method of claim 1 wherein charging the low voltage battery with a starter generator comprises charging the low voltage battery with a belt-driven starter generator coupled to the engine.

5. The method of claim 1 wherein detecting the fault in the at least one charge enabling component comprises detecting the fault at the DC-DC converter.

6. The method of claim 1 wherein detecting the fault in the at least one charge enabling component comprises detecting the fault at a contactor based on a request to be opened due to the high voltage battery failing.

7. The method of claim 1 wherein detecting the fault in the at least one charge enabling component comprises detecting the fault as a welded contactor.

8. The method of claim 1 wherein detecting the fault in the at least one charge enabling component comprises detecting the fault at a transmission.

9. The method of claim 1 wherein detecting the fault in the at least one charge enabling component comprises detecting a loss of communication with the DC-DC converter, the starter generator, or the high voltage battery.

10. The method of claim 1 wherein detecting the fault in the at least one charge enabling component comprises detecting the fault as a high voltage inverter failure.

11. A hybrid vehicle comprising:
an engine,
a high voltage battery;
a low voltage battery;
at least one charge enabling components comprising at least a DC-DC converter;
a supervisory controller programmed to enable charging of the low voltage battery from a high voltage battery through the DC-DC converter;
said supervisory controller programmed to determine a fault in the at least one charge enabling component;
said supervisory controller programmed to, based on the fault, enable charging of the low voltage battery from a starter generator based on the fault and disable charging of the low voltage battery from the high voltage battery using the DC-DC converter.

12. The hybrid vehicle of claim 11 wherein the supervisory controller is programmed to enable charging of the low voltage battery from a starter generator before disabling charging of the low voltage battery from the high voltage battery using the DC-DC converter.

13. The hybrid vehicle of claim 11 wherein the supervisory controller is programmed to enable charging of the low voltage battery through the DC-DC converter when no fault is detected and, is programmed to disable the starter generator from charging the low voltage battery after performing enabling.

14. The hybrid vehicle of claim 11 wherein the supervisory controller is programmed to charge the low voltage battery with a belt-driven starter generator coupled to the engine.

15. The hybrid vehicle of claim 11 wherein the supervisory controller is programmed to detect the fault in the at least one charge enabling component by being programmed to detect the fault at the DC-DC converter, detect the fault at a contactor, detect the fault at a transmission, detect a loss of communication with the DC-DC converter, the starter generator, or the high voltage battery, and detect the fault at a high voltage inverter failure.

16. The hybrid vehicle of claim 15 wherein the supervisory controller is programmed to determine the fault at the contactor by being programmed to determine a request to be opened due to the high voltage battery failing, and being programmed to detect the fault at a welded contactor

17. A method of operating a hybrid vehicle having a high voltage battery, a low voltage battery and at least one charge enabling component comprising:
enabling charging of the low voltage battery from a high voltage battery through a DC-DC converter;
charging the low voltage battery with the high voltage battery and the at least one charge enabling component comprising at least the DC-DC converter;
detecting a limp home mode being entered and based on the limp home mode being entered,
enabling charging of the low voltage battery from a starter generator;
disabling charging of the low voltage battery from the high voltage battery using the DC-DC converter.

18. The method of claim 17 wherein enabling charging of the low voltage battery from the starter generator is performed before disabling charging of the low voltage battery from the high voltage battery using the DC-DC converter.

19. The method of claim 17 further comprising when no fault is detected and after enabling disabling the starter generator from charging the low voltage battery and enabling charging of the low voltage battery through the DC-DC converter.

20. The method of claim 17 wherein detecting the limp home mode comprises detecting a fault in the at least one charge enabling component by detecting the fault at the DC-DC converter, detecting the fault at a contactor based on a request to be opened due to the high voltage battery failing, detecting the fault a welded contactor, detecting the fault at a transmission, detecting a loss of communication with the DC-DC converter, the starter generator, or the high voltage battery, and detecting the fault at a high voltage inverter failure.
